(19) United States
(12) Patent Application Publication
(10) Pub. No.: US 2026/0294171 A1
(43) Pub. Date: Oct. 1, 2026

(54) FRYER AND COOKING APPARATUS

(71) Applicant: Haohong Electric Technology (Hubei) Co., Ltd., Huanggang (CN)

(72) Inventor: Min WANG, Huanggang (CN)

(73) Assignee: Haohong Electric Technology (Hubei) Co., Ltd., Huanggang (CN)

(21) Appl. No.: 19/259,233

(22) Filed: Jul. 3, 2025

(30) Foreign Application Priority Data
Mar. 31, 2025 (CN) 202520593493.8

(51) Int. Cl. A47J 37/12

(52) U.S. Cl. CPC A47J 37/1295; A47J 37/1204; A47J 37/1242; A47J 37/129

(57) ABSTRACT

A fryer includes a pot body, a frying basket and a handle assembly, and the pot body is provided with an open cavity. The frying basket is arranged in the open cavity, and the outer wall surface of the frying basket is provided with a clamping member and an inserting block. The handle assembly includes a gripping rod corresponding to the inserting block, a hook connected to the gripping rod and a locking ring slidably arranged on the gripping rod. The hook is clamped with the clamping member, and the locking ring is slidable along the gripping rod so that the inserting block is inserted into the locking ring.

### CROSS-REFERENCE TO RELATED APPLICATIONS

This application claims priority to Chinese Patent Application No. 202520593493.8, filed on Mar. 31, 2025, the entire contents of which are incorporated herein by reference.

### TECHNICAL FIELD

The present application relates to the technical field of food processing apparatus, and in particular to a fryer and a cooking apparatus.

### BACKGROUND

A fryer is a kitchen apparatus for frying food, which is widely used in homes, restaurants, snack stands and other places. It can quickly fry food to crispy outside and tender inside by high-temperature frying, and is an indispensable tool for making fried food. However, due to the unreasonable structural design of the traditional fryer, the fryer cannot achieve closed frying and cannot meet the actual use needs of users.

Therefore, it is necessary to provide a new fryer and a cooking apparatus to solve the above technical problems.

### SUMMARY

The main purpose of the present application is to provide a fryer and a cooking apparatus, aiming to solve the technical problem that the fryer cannot achieve closed frying due to the unreasonable structural design of the fryer.

In order to achieve the above purpose, the present application provides a fryer, including:
a pot body provided with an open cavity;
a frying basket arranged in the open cavity, and an outer wall surface of the frying basket being provided with a clamping member and an inserting block; and
a handle assembly including a gripping rod corresponding to the inserting block, a hook connected to the gripping rod, and a locking ring slidably arranged at the gripping rod ;
wherein the hook is clamped with the clamping member, the locking ring is slidable along the gripping rod, so that the inserting block is inserted into the locking ring.

In an embodiment, the clamping member includes a clamping block in a semi-circular shape, the clamping block is arranged at the outer wall surface of the frying basket and is surrounded by the frying basket to form a clamping hole, and a portion of the hook is inserted into the clamping hole along a vertical direction of a sliding of the locking ring.

In an embodiment, the clamping member includes a clamping block in a circular shape, the clamping block is arranged at the outer wall surface of the frying basket, the clamping block is provided with a clamping hole, and a portion of the hook is inserted into the clamping hole along a vertical direction of a sliding of the locking ring.

In an embodiment, the hook includes a first rod body, a second rod body and a third rod body connected in sequence; and
the first rod body and the third rod body are both arranged at a same side of the second rod body and are surrounded by the second rod body to form an accommodating groove, the first rod body is connected to the gripping rod, the third rod body is inserted into the clamping hole along the vertical direction of the sliding of the locking ring, and the clamping block is accommodated in the accommodating groove.

In an embodiment, the fryer includes two handle assemblies;
the gripping rods of the two handle assemblies are both inserted into the locking ring and connected by a connecting rod, and the hooks of the two handle assemblies are both clamped with the clamping member; and
the inserting block is arranged between the gripping rods of the two handle assemblies and is inserted into the locking ring.

In an embodiment, an upper end surface of the inserting block is higher than an upper end surface of the gripping rod, and an end of the inserting block away from the frying basket is inclined from a side away from the pot body to a side close to the pot body along a direction from the frying basket to the gripping rod.

In an embodiment, a lower end surface of the inserting block is lower than a lower end surface of the gripping rod, and an end of the inserting block away from the frying basket is inclined from a side close to the pot body to a side away from the pot body along a direction from the frying basket to the gripping rod.

In an embodiment, the gripping rod is provided with a gripping block, and the pot body is provided with a plurality of gripping handles evenly spaced along its circumferential direction.

In an embodiment, the frying basket includes a frame and a filter screen, the frame is provided with an accommodating cavity, and the filter screen is arranged in the accommodating cavity and connected to the frame.

In an embodiment, the frame includes an upper ring, a lower ring and a plurality of connecting rods connecting the upper ring and the lower ring;
the upper ring, the lower ring and the plurality of connecting rods are all connected to the filter screen; and
the lower ring is provided with a plurality of bending rods, and each of the bending rods protrudes from the lower ring in a direction away from the upper ring.

The present application also provides a cooking apparatus, including:
a furnace body provided with an open storage cavity and a heating unit arranged in the storage cavity;
a baking tray arranged at an opening of the storage cavity and located above the heating unit, and the baking tray being provided with an accommodating hole; and
the fryer described above, and the pot body being arranged in the accommodating hole and is located above the heating unit.

The technical solution of the present application is to provide a hook that can be clamped with a clamping member and a locking ring for inserting an inserting block, so that the handle assembly is detachably connected to the frying basket. When frying food, the user only needs to detach the handle assembly to cover the pot lid of the pot body to achieve closed frying. In the present embodiment, the pot body is configured to hold oil, the frying basket is configured to hold food, and the handle assembly can be held by the user so that the user can place the frying basket in the pot body. The hook can be clamped with the clamping member to connect the handle assembly with the frying basket. The locking ring can slide along the gripping rod and allow the inserting block to be inserted; when the inserting block is inserted into the locking ring, the locking ring can lock the positions of the handle assembly and the frying basket to ensure that the connection between the handle assembly and the frying basket is reliable; when the inserting block is disengaged from the locking ring, the user can adjust the position of the hook through the gripping rod to disengage the hook from the clamping member and detach the handle assembly from the frying basket. In an embodiment, in actual use, when the user needs to fry food in a closed manner, the user only needs to toggle the locking ring to make the locking ring slide along the gripping rod until the inserting block is disengaged from the locking ring; then, the position of the hook is adjusted by the gripping rod to disengage the hook from the clamping member, and the handle assembly can be detached; at this time, since there is no restriction of the handle assembly, the user can completely place the frying basket into the pot body and cover the pot lid to achieve closed frying. The fryer is designed to be detachably connected to the handle assembly and the frying basket, so that the user can fry food in a closed manner, which can improve the user's experience. In addition, during transportation, the frying basket and the handle assembly can be separated and transported separately, which can reduce the transportation space required for transporting the frying basket and reduce transportation costs. The frying basket is applied to the technical field of food processing apparatus.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic overall structural diagram of a fryer according to an embodiment of the present application.

FIG. 2 is a schematic diagram of the connection between a frying basket and a handle assembly according to an embodiment of the present application.

FIG. 3 is a schematic structural diagram of the frying basket according to an embodiment of the present application.

FIG. 4 is a schematic structural diagram of the handle assembly according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

In addition, the technical solutions between the various embodiments of the present application can be combined with each other, but they must be based on the realization of ordinary technicians in the field. When the combination of technical solutions is contradictory or cannot be realized, it should be considered that such a combination of technical solutions does not exist and is not within the scope of protection required by the present application.

A fryer is a kitchen apparatus for frying food, which is widely used in homes, restaurants, snack stands and other places. It can quickly fry food to crispy outside and tender inside by high-temperature frying, and is an indispensable tool for making fried food. However, in the actual production process, researchers found that the frying basket and handle of the fryer are mostly one-piece structures. Due to the limitation of the handle, when the user is frying food, the pot lid cannot completely cover the pot body of the fryer, which also causes the oil to overflow easily during the frying process, affecting the user experience and even causing damage to the user.

The present application provides a fryer and a cooking apparatus, aiming to solve the technical problem that the fryer cannot realize closed frying due to the unreasonable structural design of the fryer.

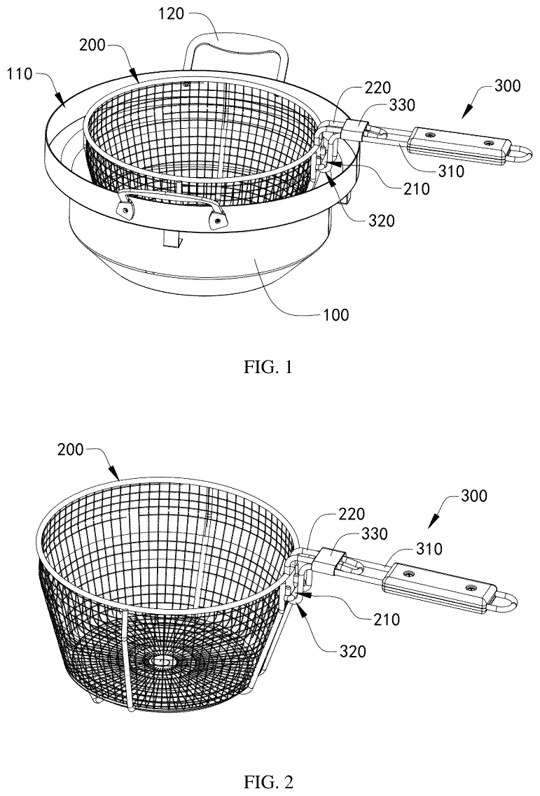

As shown in FIG. 1 and FIG. 2, in an embodiment of the present application, the fryer includes a pot body 100, a frying basket 200 and a handle assembly 300. The pot body 100 is provided with an open cavity 110, the frying basket 200 is arranged in the open cavity 110, and the outer wall surface of the frying basket 200 is provided with a clamping member 210 and an inserting block 220. The handle assembly 300 includes a gripping rod 310 corresponding to the inserting block 220, a hook 320 connected to the gripping rod 310, and a locking ring 330 slidably arranged on the gripping rod 310, and the hook 320 is clamped with the clamping member 210; the locking ring 330 is slidable along the gripping rod 310, so that the inserting block 220 is inserted into the locking ring 330.

The technical solution of the present application is to provide a hook 320 that can be clamped with the clamping member 210 and a locking ring 330 for inserting the inserting block 220, so that the handle assembly 300 is detachably connected to the frying basket 200. When frying food, the user only needs to detach the handle assembly 300 to cover the pot lid of the pot body 100 to achieve closed frying.

In the present embodiment, the pot body 100 is configured to hold oil, the frying basket 200 is configured to hold food, and the handle assembly 300 can be held by the user so that the user can place the frying basket 200 in the pot body 100. The hook 320 can be clamped with the clamping member 210 to connect the handle assembly 300 with the frying basket 200. The locking ring 330 can slide along the gripping rod 310 and allow the inserting block 220 to be inserted; when the inserting block 220 is inserted into the locking ring 330, the locking ring 330 can lock the positions of the handle assembly 300 and the frying basket 200 to ensure a reliable connection between the handle assembly 300 and the frying basket 200; when the inserting block 220 is disengaged from the locking ring 330, the user can adjust the position of the hook 320 through the gripping rod 310 to disengage the hook 320 from the clamping member 210 and detach the handle assembly 300 from the frying basket 200.

In an embodiment, in actual use, when the user needs to fry food in a closed manner, the user only needs to toggle the locking ring 330 to make the locking ring 330 slide along the gripping rod 310 until the inserting block 220 is disengaged from the locking ring 330; then, the position of the hook 320 is adjusted by the gripping rod 310 to disengage the hook 320 from the clamping member 210, and the handle assembly 300 can be detached; at this time, since there is no restriction of the handle assembly 300, the user can completely place the frying basket 200 into the pot body 100 and cover the pot lid to achieve closed frying. The frying pot is designed to be detachably connected to the handle assembly 300 and the frying basket 200, so that the user can fry food in a closed manner, which can improve the user's experience. In addition, during transportation, the frying basket 200 and the handle assembly 300 can be separated and transported separately, which can reduce the transportation space required for transporting the frying basket 200 and reduce transportation costs. The frying basket 200 is applied to the technical field of food processing apparatus.

It should be noted that the fryer in the present embodiment can be used not only for frying food, but also for cooking food. It only needs to replace the oil in the fryer with water. The inserting block 220 can be a block structure or a rod structure formed by bending a straight rod. In an embodiment, the inserting block 220 is a U-shaped rod. When the fryer is actually manufactured or produced, in order to ensure that the pot lid can completely cover the pot body 100, the size of the frying basket 200 and the inserting block 220 mounted at the frying basket 200 must be limited to a certain extent to ensure that the frying basket 200 and the inserting block 220 can be completely placed in the pot body 100 in a flat or inclined manner; for example, the frying basket 200 and the inserting block 220 in the present embodiment can be completely placed in the pot body 100 in an inclined manner, and when placing the pot lid, the inserting block 220 will not interfere with the pot lid.

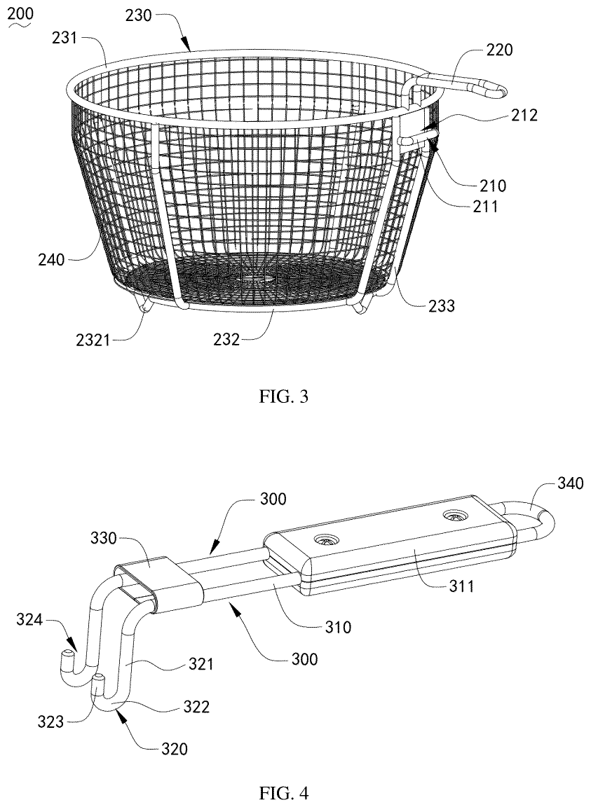

As shown in FIG. 2 and FIG. 3, in an embodiment of the present application, the clamping member 210 includes a clamping block 211 in a semi-circular shape. The clamping block 211 is arranged at the outer wall of the frying basket 200 and is surrounded by the frying basket 200 to form a clamping hole 212, and a portion of the hook 320 is inserted into the clamping hole 212 in a vertical direction of a sliding of the locking ring 330. Alternatively, the clamping member 210 includes a clamping block 211 in a circular shape. The clamping block 211 is arranged at the outer wall of the frying basket 200, the clamping block 211 is provided with a clamping hole 212, and the portion of the hook 320 is inserted into the clamping hole 212 in a vertical direction of the sliding of the locking ring 330. In the present embodiment, the clamping of the handle assembly 300 and the frying basket 200 is achieved by the cooperation between the clamping block 211 and the clamping hole 212. The handle assembly 300 and the frying basket 200 are simple in structure, can simplify the structure of the frying pot, reduce the difficulty of disassembling and assembling the handle assembly 300, and reduce the difficulty and cost of manufacturing the fryer. In an embodiment, when disassembling the handle assembly 300, the user only needs to slide the locking ring 330 to disengage the inserting block 220 from the locking ring 330, and then hold the gripping rod 310 to rotate the handle assembly 300 to a certain angle to disengage the hook 320 from the clamping hole 212, and the handle assembly 300 can be disassembled. It should be noted that the hook 320 is inserted into the clamping hole 212 along the vertical direction of the sliding of the locking ring 330, and the inserting block 220 is inserted into the locking block along the sliding direction of the locking ring 330, that is, the hook 320 and the locking ring 330 can limit the position of the handle assembly 300 in two different directions to ensure that the connection between the handle assembly 300 and the frying basket 200 is reliable.

As shown in FIG. 4, in an embodiment of the present application, the hook 320 includes a first rod 321, a second rod 322 and a third rod 323 connected in sequence. The first rod 321 and the third rod 323 are arranged at the same side of the second rod 322 and are surrounded by the second rod 322 to form an accommodating groove 324. The first rod 321 is connected to the gripping rod 310. The third rod 323 is inserted into the clamping hole 212 along the vertical direction of the locking ring 330. The clamping block 211 is accommodated in the accommodating groove 324. In the present embodiment, the hook 320 is a U-shaped structure. When the third rod 323 of the hook 320 is inserted into the clamping hole 212, the clamping block 211 is accommodated in the accommodating groove 324. In addition, the handle assembly 300 in the present embodiment is formed by bending a straight rod, which can improve the structural strength of the handle assembly 300. It should be noted that, in addition to the U-shaped structure, the hook 320 can also adopt a Z-shaped structure, that is, the first rod 321 and the third rod 323 are respectively arranged at the opposite sides of the second rod 322.

As shown in FIG. 4, in an embodiment of the present application, two handle assemblies 300 is provided; the gripping rods 310 of the two handle assemblies 300 are both inserted into the locking ring 330 and connected by the connecting rod 340, and the hooks 320 of the two handle assemblies 300 are both clamped with the clamping member 210; the inserting block 220 is arranged between the gripping rods 310 of the two handle assemblies 300 and can be inserted into the locking ring 330. In the present embodiment, the handle assemblies 300 are provided to two, which can increase the lateral area of the gripping rod 310 of the handle assembly 300 when the user grasps the handle assembly 300, so as to ensure that the user can grasp the handle assembly 300 more firmly. The two handle assemblies 300 in the present embodiment are formed by bending a straight rod, which can improve the structural strength of the handle assembly 300.

As shown in FIG. 2, in an embodiment of the present invention, the upper end surface of the inserting block 220 is higher than the upper end surface of the gripping rod 310; and the end of the inserting block 220 away from the frying basket 200 is inclined from the side away from the pot body 100 to the side close to the pot body 100 along the direction from the frying basket 200 to the gripping rod 310. In the present embodiment, the upper end surface of the inserting block 220 is higher than the upper end surface of the gripping rod 310, so that when the inserting block 220 is inserted into the locking ring 330, the upper end surface of the inserting block 220 can abut against the inner wall of the locking ring 330, so as to generate friction between the inserting block 220 and the locking ring 330, which can reduce the risk of the inserting block 220 and the locking ring 330 being separated when the user uses the fryer. The end of the inserting block 220 away from the frying basket 200 is designed to be inclined, which can provide guidance for the locking ring 330 when the locking ring 330 slides along the gripping rod 310, thereby reducing the difficulty of assembling the handle assembly 300 and the frying basket 200. In another embodiment of the present application, the lower end surface of the inserting block 220 is lower than the lower end surface of the gripping rod 310; and the end of the inserting block 220 away from the frying basket 200 is inclined from the side close to the pot body 100 to the side away from the pot body 100 along the direction from the frying basket 200 to the gripping rod 310. The effect of the lower end surface of the inserting block 220 being lower than the lower end surface of the gripping rod 310 is similar to the effect of the upper end surface of the inserting block 220 being higher than the upper end surface of the gripping rod 310 mentioned above, and the end of the inserting block 220 away from the frying basket 200 is designed to be inclined, which is also similar to the above-mentioned effect, and will not be repeated here.

As shown in FIG. 1 and FIG. 4, in an embodiment of the present application, the gripping rod 310 is provided with a gripping block 311, and the pot body 100 is evenly spaced along its circumferential direction. A plurality of gripping handles 120 are evenly spaced along the circumferential direction of the pot body 100. In the present embodiment, the gripping block 311 is provided for the user to grasp, which can improve the user's experience. The plurality of gripping handles 120 evenly spaced along the circumference of the pot body 100 facilitate the user to take the fryer to transfer or adjust the position of the fryer. In the present embodiment, the two gripping handles 120 are provided.

As shown in FIG. 3, in an embodiment of the present application, the frying basket 200 includes a frame 230 and a filter screen 240. The frame 230 is provided with an accommodating cavity. The filter screen 240 is arranged in the accommodating cavity and connected to the frame 230. In the present embodiment, the frame 230 is the main structure of the frying basket 200, which can provide sufficient structural support for the frying basket 200 to ensure the structural stability of the frying basket 200. The filter screen 240 is configured to hold food and filter screen oil. In an embodiment, the filter screen 240 is composed of a plurality of steel wires connected in an interlaced manner.

In an embodiment of the present application, the frame 230 includes an upper ring 231, a lower ring 232, and a plurality of connecting rods 233 connecting the upper ring 231 and the lower ring 232. The upper ring 231, the lower ring 232, and the plurality of connecting rods 233 are all connected to the filter screen 240; the lower ring 232 is provided with a plurality of bending rods 2321, and each bending rod 2321 protrudes from the lower ring 232 in a direction away from the upper ring 231. In the present embodiment, the plurality of bending rods 2321 provided at the lower ring 232 can support the frying basket 200 when the frying basket 200 is placed in the pot body 100, thereby reducing the contact area between the frying basket 200 and the bottom surface of the pot body 100.

The present application also provides a cooking apparatus, which includes the above-mentioned fryer. The specific structure of the fryer refers to the above-mentioned embodiment. Since the cooking apparatus adopts all the technical solutions of all the above-mentioned embodiments, it at least has all the beneficial effects brought by the technical solutions of the above-mentioned embodiments, which will not be repeated here. The cooking apparatus includes a furnace body, a baking tray and the above-mentioned fryer, the furnace body is provided with an open storage cavity and a heating unit arranged in the storage cavity, the baking tray is arranged at the opening of the storage cavity and is located above the heating unit, and the baking tray is provided with an accommodating hole, and the pot body 100 is arranged in the accommodating hole and is located above the heating unit. Specifically, the storage cavity is configured to store the heating unit to heat the oil in the pot body 100. The accommodating hole is configured to place the pot body 100 to fix the position of the pot body 100. In the present embodiment, the pot body 100 is a cylindrical structure with multiple different diameters, the accommodating hole is circular, and the diameter of the accommodating hole is smaller than the maximum diameter of the pot body 100. In addition, the pot body 100 can also be designed as a polygonal structure with multiple different sizes, accordingly, the accommodating hole is a polygonal structure similar to the pot body 100, and the size of the accommodating hole is smaller than the maximum size of the pot body 100. For example, the pot body 100 can also be a rectangular structure with multiple different sizes, the accommodating hole is a rectangular structure, and the size of the accommodating hole is smaller than the maximum size of the pot body 100. The heating unit can be a combustible material such as coal, charcoal and particles, or a heating component with a heating function. In an embodiment, in actual use, the user can design the bottom surface of the fryer to be a plane, so that the fryer can be placed directly on the baking tray, thereby reducing the opening of the baking tray and reducing the difficulty of making the baking tray; and the user can also place the fryer directly on the gas stove for heating.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A fryer, comprising:
a pot body provided with an open cavity;
a frying basket arranged in the open cavity, and an outer wall surface of the frying basket being provided with a clamping member and an inserting block; and
a handle assembly comprising a gripping rod corresponding to the inserting block, a hook connected to the gripping rod, and a locking ring slidably arranged at the gripping rod;
wherein the hook is clamped with the clamping member, the locking ring is slidable along the gripping rod, so that the inserting block is inserted into the locking ring.

2. The fryer according to claim 1, wherein the clamping member comprises a clamping block in a semi-circular shape, the clamping block is arranged at the outer wall surface of the frying basket and is surrounded by the frying basket to form a clamping hole, and a portion of the hook is inserted into the clamping hole along a vertical direction of a sliding of the locking ring.

3. The fryer according to claim 1, wherein the clamping member comprises a clamping block in a circular shape, the clamping block is arranged at the outer wall surface of the frying basket, the clamping block is provided with a clamping hole, and a portion of the hook is inserted into the clamping hole along a vertical direction of a sliding of the locking ring.

4. The fryer according to claim 2, wherein:
the hook comprises a first rod body, a second rod body and a third rod body connected in sequence; and
the first rod body and the third rod body are both arranged at a same side of the second rod body and are surrounded by the second rod body to form an accommodating groove, the first rod body is connected to the gripping rod, the third rod body is inserted into the clamping hole along the vertical direction of the sliding of the locking ring, and the clamping block is accommodated in the accommodating groove.

5. The fryer according to claim 3, wherein:
the hook comprises a first rod body, a second rod body and a third rod body connected in sequence; and
the first rod body and the third rod body are both arranged at a same side of the second rod body and are surrounded by the second rod body to form an accommodating groove, the first rod body is connected to the gripping rod, the third rod body is inserted into the clamping hole along the vertical direction of the sliding of the locking ring, and the clamping block is accommodated in the accommodating groove.

6. The fryer according to claim 1, wherein:
the fryer comprises two handle assemblies;
the gripping rods of the two handle assemblies are both inserted into the locking ring and connected by a connecting rod, and the hooks of the two handle assemblies are both clamped with the clamping member; and
the inserting block is arranged between the gripping rods of the two handle assemblies and is inserted into the locking ring.

7. The fryer according to claim 1, wherein an upper end surface of the inserting block is higher than an upper end surface of the gripping rod, and an end of the inserting block away from the frying basket is inclined from a side away from the pot body to a side close to the pot body along a direction from the frying basket to the gripping rod.

8. The fryer according to claim 1, wherein a lower end surface of the inserting block is lower than a lower end surface of the gripping rod, and an end of the inserting block away from the frying basket is inclined from a side close to the pot body to a side away from the pot body along a direction from the frying basket to the gripping rod.

9. The fryer according to claim 1, wherein the gripping rod is provided with a gripping block, and the pot body is provided with a plurality of gripping handles evenly spaced along its circumferential direction.

10. The fryer according to claim 1, wherein the frying basket comprises a frame and a filter screen, the frame is provided with an accommodating cavity, and the filter screen is arranged in the accommodating cavity and connected to the frame.

11. The fryer according to claim 10, wherein:
the frame comprises an upper ring, a lower ring and a plurality of connecting rods connecting the upper ring and the lower ring;
the upper ring, the lower ring and the plurality of connecting rods are all connected to the filter screen; and
the lower ring is provided with a plurality of bending rods, and each of the bending rods protrudes from the lower ring in a direction away from the upper ring.

12. A cooking apparatus, comprising:
a furnace body provided with an open storage cavity and a heating unit arranged in the storage cavity;
a baking tray arranged at an opening of the storage cavity and located above the heating unit, and the baking tray being provided with an accommodating hole; and
the fryer according to claim 1, and the pot body being arranged in the accommodating hole and is located above the heating unit.
